(19) United States
(12) Patent Application Publication
(10) Pub. No.: US 2009/0041361 A1
(43) Pub. Date: Feb. 12, 2009

(54) Character recognition apparatus, character recognition method, and computer product

(75) Inventors: Hiroaki Takebe, Kawasaki (JP); Katsuhito Fujimoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/153,015

(22) Filed: May 12, 2008

(30) Foreign Application Priority Data
Aug. 9, 2007 (JP) 2007-208612

(51) Int. Cl. G06K 9/62

(52) U.S. Cl. 382/209

(57) ABSTRACT

A character recognition apparatus includes a hash table registering unit and a recognition processing unit. The hash table registering unit creates a hash table indicating a characteristic of each of partial character images as an area of each character. The recognition processing unit divides an input image into partial input images, and calculates a characteristic of each partial input image. The recognition processing unit searches the hash table for a partial character image having a characteristic similar to that of each partial input image. The recognition processing unit compares a positional relationship of the partial input images with that of the partial character images to determine whether they match, and recognizes a character in each area of the input image.

### BACKGROUND OF THE INVENTION

1. Field of the Invention

The present invention relates to a character recognition technology.

2. Description of the Related Art

Character recognition has been performed in such a manner that character patterns and their characteristics are stored in advance for each character type in the form of a dictionary, then similarity is obtained by comparing the stored information with an image to be recognized, and a character type having the highest similarity is output as a result of character recognition.

In the process of recognizing character types from character patterns and their characteristics, when a character is in contact with other characters or symbols in an image to be recognized, a shape of a character pattern is affected, which leads to a miscalculation of the characteristics and thus decreases recognition accuracy. To solve such a problem, there is a known character recognition technology in which a plurality of patterns in contact is divided to recognize a character.

Japanese Patent Application Laid-open No. H6-111070 discloses a conventional technology in which a pair of disconnection-line end points constituting a line regarded as a disconnection line of each character pattern is extracted from a candidate of disconnection-line end points detected from an external-and-internal outline portion of a character string pattern including a plurality of character patterns in contact with each other. A character pattern is then extracted based on a line connecting between the two disconnection-line end points. This achieves accurate extraction of a character even when character strings are in close contact with each other.

Japanese Patent Application Laid-open No. 2001-22889 discloses another conventional technology in which character recognition of documents in a tabular form, such as a book, uses a dictionary of characters not contacting with a rule and a dictionary of characters contacting with a rule as a recognition dictionary. It is determined whether a character is in contact with a rule in a recognition area, and a dictionary used to recognize a character is selected according to a determination result. Thus, a character in a book or the like can be recognized in high precision.

However, the former conventional technology can be applied to only where character patterns are in contact with each other or where a specific shape is in contact with a character pattern like a character string in a circle. Similarly, the latter conventional technology can be applied to only where a character pattern is in contact with a rule.

That is, with the above conventional technologies, when a shape of a pattern in contact with a character pattern is unclear, it is difficult to recognize a character. Therefore, to read, by a computer, contents of, for example, an application form or a questionnaire filled with a manually-written mark including a character string and a number, it is necessary to recognize a character from a pattern where a character is overlapped with the mark. However, because marks that users write vary in shape and also a mark contacts a character pattern in various manners, it is unable to sufficiently recognize a character.

Therefore, there is a need of a technology for recognizing with high accuracy a character overlapped with a pattern in an arbitrary shape regardless of a shape of overlap between a character pattern and a mark.

### SUMMARY OF THE INVENTION

It is an object of the present invention to at least partially solve the problems in the conventional technology.

According to an aspect of the present invention, there is provided a character recognition apparatus that recognizes a character in an input image. The character recognition apparatus includes a first dividing unit that divides each of a plurality of character images into a plurality of partial character images each representing a part of a character image; a storage unit that stores therein a search table that associates a characteristic of each of the partial character images with a positional relationship between the partial character images in the character image and a character type of the character image; a second dividing unit that divides the input image into a plurality of partial input images; a calculating unit that calculates a characteristic of each of the partial input images; a searching unit that searches the search table for a partial character image having a characteristic similar to the characteristic calculated by the calculating unit; a determining unit that counts, for each character type, partial character images obtained by the searching unit, and determines whether a positional relationship between the partial character images matches a positional relationship between the partial input images; an extracting unit that extracts, when the positional relationship between the partial character images matches the positional relationship between the partial input images, the partial input images as a character candidate; and a recognizing unit that recognizes, when number of the partial input images of the character candidate is equal to or more than a predetermined value, the partial input images as constituent elements of a character represented by the character type.

According to another aspect of the present invention, there is provided a character recognition method for recognizing a character in an input image. The character recognition method includes first dividing each of a plurality of character images into a plurality of partial character images each representing a part of a character image; storing, in a search table, a characteristic of each of the partial character images in association with a positional relationship between the partial character images in the character image and a character type of the character image; second dividing an input image into a plurality of partial input images; calculating a characteristic of each of the partial input images; searching the search table for a partial character image having a characteristic similar to the characteristic calculated at the calculating; counting partial character images obtained at the searching for each character type; determining whether a positional relationship between the partial character images matches a positional relationship between the partial input images for each character type; extracting, when the positional relationship between the partial character images matches the positional relationship between the partial input images, the partial input images as a character candidate; and recognizing, when number of the partial input images of the character candidate is equal to or more than a predetermined value, the partial input images as constituent elements of a character represented by the character type.

According to still another aspect of the present invention, there is provided a computer-readable recording medium that stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a character recognition apparatus according to an embodiment of the present invention;

FIG. 2 is a functional block diagram of a recognition processing unit shown in FIG. 1;

FIG. 3 is a schematic diagram for explaining hash-table registration by a hash-table registering unit shown in FIG. 1;

FIG. 4 is a schematic diagram for explaining characteristic calculation for an input image and character category search by the recognition processing unit;

FIG. 5 is a schematic diagram for explaining counting of partial character images for each character category as a search result;

FIG. 6 is a schematic diagram for explaining graphing of partial input images by a position-consistency determining unit;

FIG. 7 is a schematic diagram for explaining a path connection between nodes;

FIG. 8 is a schematic diagram for explaining extraction and evaluation of a clique;

FIG. 9 is a schematic diagram for explaining recognition of a character area by a character determining unit shown in FIG. 2;

FIG. 10 is an example of vote result data that the position-consistency determining unit generates from a search result obtained by a character-category searching unit shown in FIG. 2;

FIG. 11 is an example of graph data generated by the position-consistency determining unit;

FIG. 12 is a flowchart of a process of hash-table registration;

FIG. 13 is a flowchart of a process of character recognition;

FIG. 14 is a schematic diagram for explaining a modification of normalization at the time of creating a hash table;

FIG. 15 is a schematic diagram for explaining application of different mesh divisions to one character image;

FIG. 16 is a schematic diagram for explaining a recognition process based on (n, dx, dy) characteristics;

FIG. 17 is a schematic diagram of an image recognition system according to the embodiment; and

FIG. 18 is a schematic diagram of a computer that executes a computer program for implementing the character recognition apparatus.

### DETAILED DESCRIPTION OF THE PREFERRED EMBODIMENTS

Exemplary embodiments of the present invention are explained in detail below with reference to the accompanying drawings.

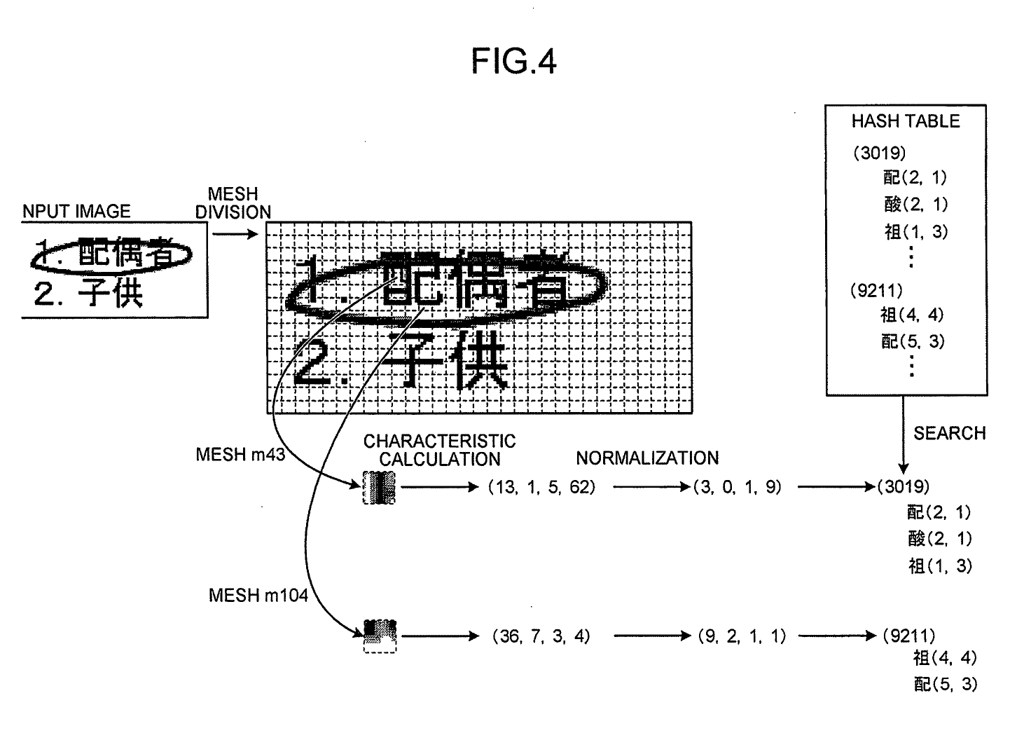

According to an embodiment of the present invention, a character in an input image is recognized based on a part thereof overlapped with no character pattern without separating a character pattern from other patterns. For example, as shown in FIG. 4, when a mark is manually written on a character string “1. [symbol] in an input image and the mark joins characters, it is difficult to extract each character. Even in such a case, the character string “1. [symbol] can be recognized from the characteristic of a part not overlapped with the mark.

For this character recognition, first, an input image is divided into partial input images, and it is determined to which part of what character a characteristic of each partial input image corresponds. When a positional relationship of partial input images, each similar to a part of the same character, matches that of the corresponding character, it is determined that these partial input images are part of the character.

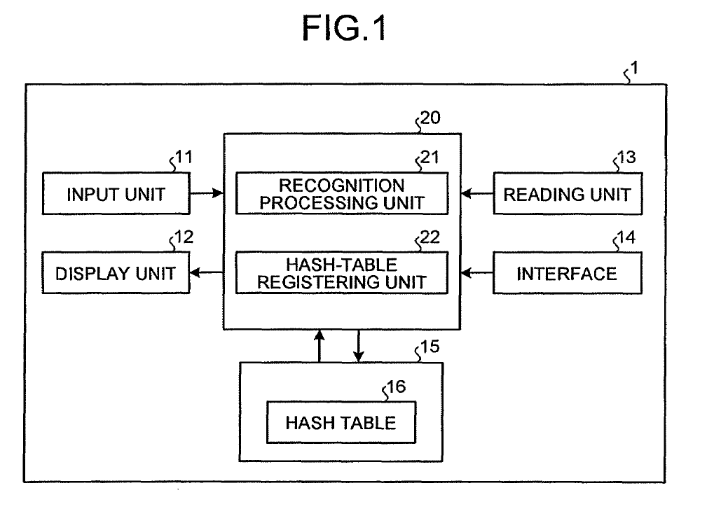

FIG. 1 is a functional block diagram of a character recognition apparatus 1 according to an embodiment of the present invention. The character recognition apparatus 1 includes in the apparatus an input unit 11, a display unit 12, an reading unit 13, an interface 14, a storage unit 15, and a control unit 20.

The input unit 11 receives an operation input from an operator, and can be a keyboard and the like. The display unit 12 displays output for the operator, and can be a liquid display and the like.

The reading unit 13 reads an input image, and can be a scanner and the like. The interface 14 is connected to an external device and transmits and receives data.

The storage unit 15 stores therein various kinds of data used for the processing of the character recognition apparatus 1, and various kinds of data generated by the processing. In the example, the storage unit 15 stores therein a hash table 16 showing a local characteristic of each character category. In this case, the character category means a character type and a character name.

The control unit 20 controls the character recognition apparatus 1, and includes a recognition processing unit 21 and a hash-table registering unit 22. The hash-table registering unit 22 creates the hash table 16 using a character image sample for learning obtained via the interface 14, and registers the hash table in the storage unit 15.

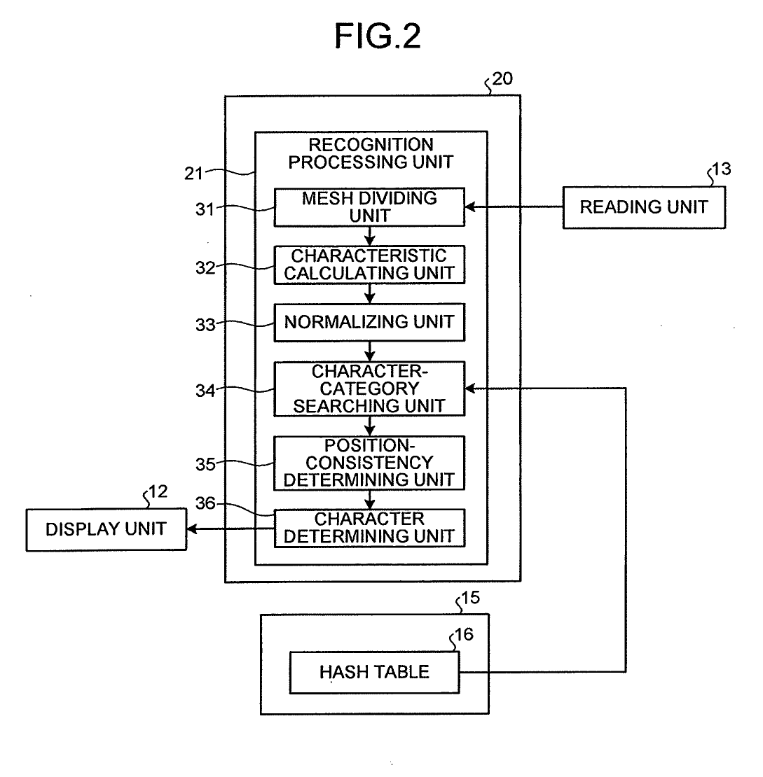

The recognition processing unit 21 recognizes a character from an input image read by the reading unit 13. FIG. 2 is a functional block diagram of the recognition processing unit 21. The recognition processing unit 21 includes in the apparatus a mesh dividing unit 31, a characteristic calculating unit 32, a normalizing unit 33, a character-category searching unit 34, a position-consistency determining unit 35, and a character determining unit 36.

The mesh dividing unit 31 divides an input image into a mesh shape, and generates a partial input image. The characteristic calculating unit 32 calculates characteristic of partial input images generated by the mesh dividing unit 31. The normalizing unit 33 normalizes the characteristic calculated by the characteristic calculating unit 32.

The character-category searching unit 34 searches the hash table 16 for a partial character image of a character category of which characteristic is similar to the characteristic normalized by the normalizing unit 33 as a key for each partial input image.

The position-consistency determining unit 35 counts the partial character images obtained by the character-category searching unit 34, and determines consistency between a positional relationship of partial character images in each character category with that of partial input images in the input image. That is, the position-consistency determining unit 35 determines whether the positional relationship between the partial character images matches the positional relationship between the partial input images. The position-consistency determining unit 35 thus extracts as a character candidate a set of partial input images consistent with a positional relationship of partial character images.

When a character candidate extracted by the position-consistency determining unit 35 has a predetermined number or more of partial input images, the character determining unit 36 determines that a partial input image held by the character candidate is a constituent element of a character category shown by the character type, and displays this character category in the display unit 12.

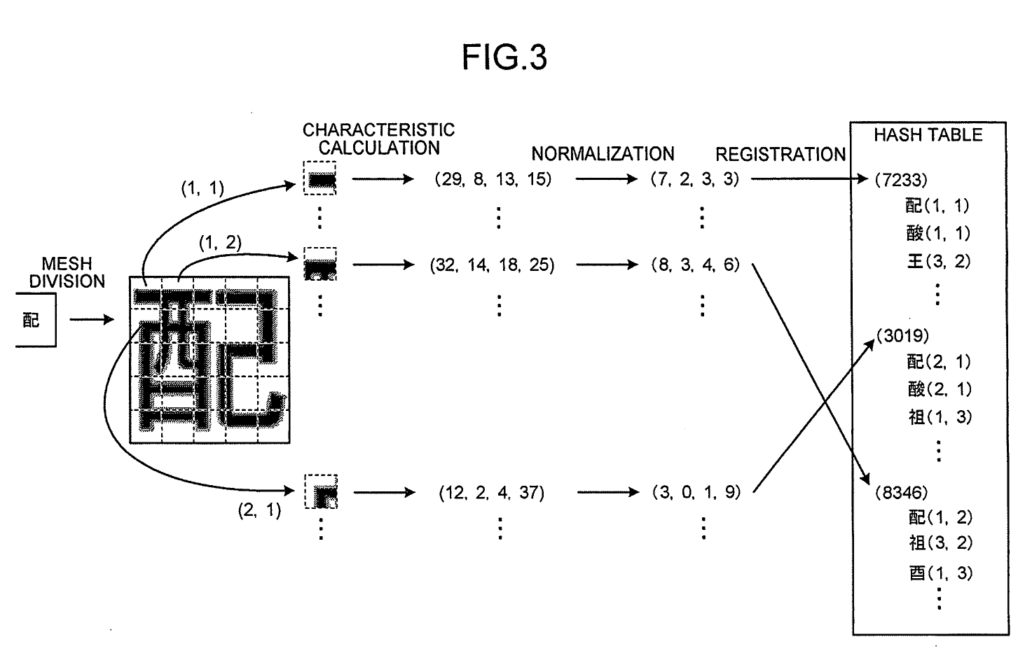

FIG. 3 is a schematic diagram for explaining registration in the hash table 16 performed by the hash-table registering unit 22. The hash-table registering unit 22 obtains a character image sample for learning, via the interface 14, and divides the obtained character image into meshes by n×n (n=5, for example). The hash-table registering unit 22 calculates a characteristic of each mesh (each partial character image), using each mesh obtained by the division as a partial character image of the character image.

Various methods are available for calculating characteristics. For example, there can be used Weighted Direction Code Histogram. Reference may be had to, for example, “Handwritten KANJI and HIRAGANA Character Recognition Using Weighted Direction Index Histogram Method”, Trans. of IEICE(D), vol. J70-D, No. 7 pp. 1390-1397 July 1987, which is incorporated herein by reference. From this weighted direction code histogram, there can be obtained, as characteristic vectors having a plurality of dimensions corresponding to the number of direction codes. For example, use of four-dimensional characteristic vectors is explained below.

In FIG. 3, the hash-table registering unit 22 divides a character image [symbol] as a learning character sample, by 5×5. Each mesh obtained by the division is regarded as i-th row and j-th column, and also each mesh is identified as [symbol] (1, 1) to [symbol] (5, 5). When characteristic vectors of each mesh are obtained based on this, characteristic vectors of [symbol] (1, 1) are (29, 8, 13, 5), characteristic vectors of [symbol] (1, 2) are (32, 14, 18, 25), and characteristic vectors of [symbol] (2, 1) are (12, 2, 4, 37).

When there are a plurality of learning character samples for the same character category, the hash-table registering unit 22 removes character components depending on individual character images, by averaging learning sample images belonging to the same character category, thereby obtaining characteristic vectors of the character category itself.

As a result, n×n mesh characteristic vectors can be obtained for one character category. The mesh characteristic vectors are calculated for each character category.

Next, the hash-table registering unit 22 converts the mesh characteristic vectors into hash values, thereby making it possible to draw positions of the character category and the mesh based on the hash values. The mesh characteristic vectors are vectors of dimensions corresponding to the number of direction codes, and an area is normalized to take integers from 0 to 9. As a result, the mesh characteristic vectors take values of power (=10,000) of the number (=4) of ten direction codes.

While normalization can be performed in an arbitrary manner, preferably, it involves converting a similar value to the same value. For example, it is preferable that an integer quotient be obtained by dividing vectors by a predetermined value, and the quotient be forcibly replaced by 9 when the quotient exceeds 9.

In FIG. 3, the hash-table registering unit 22 divides the value of each dimension of characteristic vectors by “4”, thereby obtaining integer quotients. As a result, the characteristic vectors (29, 8, 13, 5) of [symbol] (1, 1) are normalized to (7, 2, 3, 3), the characteristic vectors (32, 14, 18, 25) of [symbol] (1, 2) are normalized to (8, 3, 4, 6), and the characteristic vectors (12, 2, 4, 37) of [symbol] (2, 1) are normalized to (3, 0 1, 9).

The hash-table registering unit 22 registers the normalized mesh-characteristic vector values in the hash table 16, by relating the normalized mesh-characteristic vector values to a character category name, and a position (i, j) of the mesh. That is, when mesh characteristic vectors (va, vb, vc, vd) are given, the hash-table registering unit 22 normalizes the mesh characteristic vectors (va, vb, vc, vd) and coverts them into (Va, Vb, Vc, Vd), thereby obtaining H=Va×1000+Vb×100+Vc×10+Vd, and recording (character category name, i, j) for H.

In FIG. 3, [symbol] (1, 1) having the normalized characteristic vectors (7, 2, 3, 3) is associated with a hash value (7233), [symbol] (1, 2) having the normalized characteristic vectors (8, 3, 4, 6) is associated with a hash value (8346), and [symbol] (2, 1) having the normalized characteristic vectors (3, 0, 1, 9) is associated with a hash value (3019).

The hash-table registering unit 22 creates the hash table 16 by performing the above process for all character categories, and stores the hash table 16 in the storage unit 15. In FIG. 3, [symbol] (1, 1), [symbol] (1, 1), and [symbol] (3, 2) are associated with each other, and are registered in the hash value (7233). In the hash value (3019) are registered [symbol] (2, 1), [symbol] (2, 1), and [symbol] (1, 3) which are associated with each other. In the hash value (8346) are registered [symbol] (1, 2), [symbol] (3, 2), and [symbol] (1, 3) which are associated with each other.

Explained below is the operation of the recognition processing unit 21. FIG. 4 is a schematic diagram for explaining characteristic calculation for an input image and character category search performed by the recognition processing unit 21. When the reading unit 13 inputs an image to the recognition processing unit 21, as shown in FIG. 4, the mesh dividing unit 31 divides the input image into meshes.

In this case, a size of a mesh is set based on a size of one character in the input image divided by n×n. For example, when resolution of an input image is 400 dots per inch (dpi), and when a size of a mesh is set to eight pixels for each of vertical and lateral directions, for an average character size having 40 pixels for each of vertical and directions, one character can be divided into meshes in a size corresponding to 5×5. For an image of other resolution, a mesh size can be set in proportion to the resolution. When sizes of peripheral characters can be recognized, a mesh size can be set based on the size of the peripheral characters.

For the meshes obtained by dividing the input image, the mesh dividing unit 31 stores in the storage unit 15 information about from which position of the input image each mesh (partial input image) is obtained.

Next, the characteristic calculating unit 32 obtains characteristic vectors of each cut-out mesh. In calculating the characteristic vectors, a weighted direction code histogram is also used like the histogram used to create the hash table. In FIG. 4, the characteristic vectors of a mesh m4 cut out from the input image are obtained as (13, 1, 5, 62), and the characteristic vectors of a mesh m104 are similarly obtained as (35, 7, 3, 4).

The normalizing unit 33 normalizes each characteristic vector calculated by the characteristic calculating unit 32, in a similar manner to that when the hash table is created. For example, the normalizing unit 33 obtains an integer quotient by dividing vectors by a predetermined value, and forcibly replaces the quotient with 9, when the quotient exceeds 9.

In FIG. 4, the normalizing unit 33 obtains an integer quotient by dividing a value of each dimension of the characteristic vectors by “4”. As a result, the characteristic vectors (13, 1, 5, 62) of the mesh m43 are normalized to (3, 0, 1, 9), and the characteristic vectors (36, 7, 3, 4) of a mesh m104 are normalized to (9, 2, 1, 1).

The character-category searching unit 34 searches the hash table 16 for a partial character image of the character category of which characteristic is similar to the normalized characteristic vectors as a key for each of the partial input image.

As a result, in FIG. 4, as partial character images similar to the mesh m43, there are obtained partial character images tied to the hash value (3019), i.e., (2, 1) of the character category [symbol] (2, 1) of the character category [symbol] , and (1, 3) of the character category [symbol] . Similarly, as partial character images similar to the mesh m104, there are obtained partial character images tied to the hash value (9211), i.e., (4, 4) of the character category [symbol] , and (5, 3) of the character category [symbol] , as a search result.

The character-category searching unit 34 searches for partial character images of all meshes cut out from the input image, i.e., the partial character images similar to the partial input images. After this, the position-consistency determining unit 35 counts the partial character images obtained as a result of the searching.

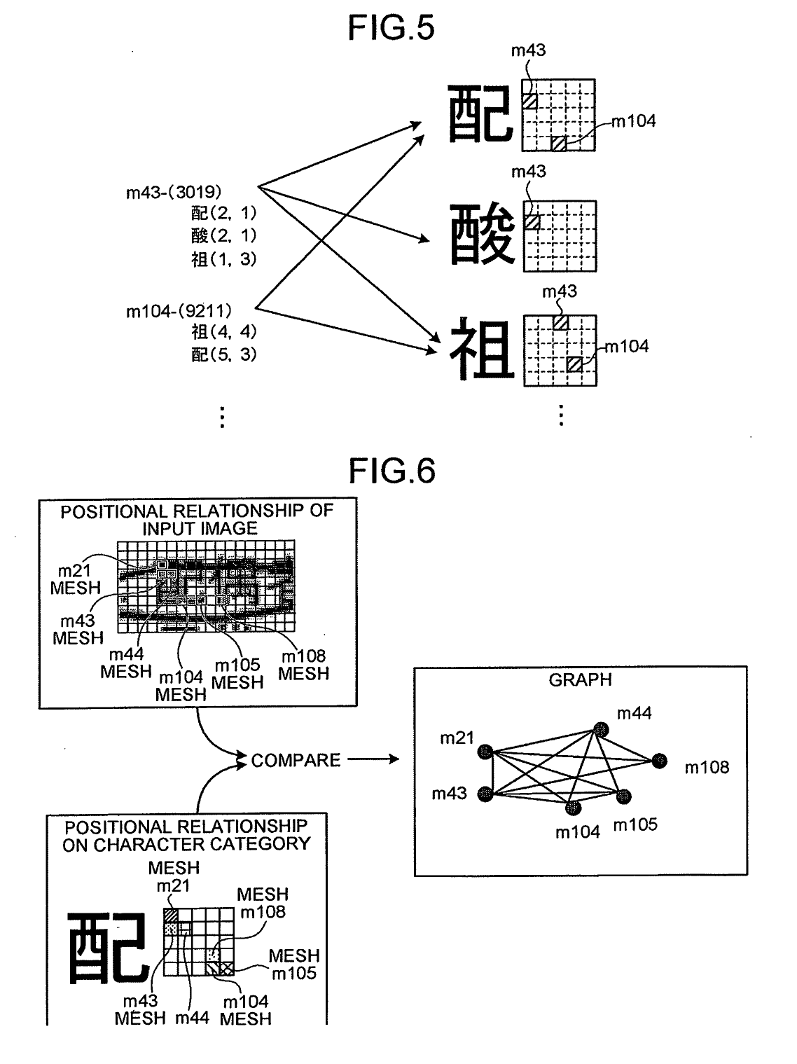

FIG. 5 is a schematic diagram for explaining counting of partial character images for each character category as a search result. In FIG. 5, search results of the meshes m43 and m104 are voted for a corresponding position of the character category, and counted. Specifically, for the character category [symbol] , the mesh m43 is voted for the position of (2, 1), and the mesh m104 is voted for the position of (5, 3). Similarly, the mesh m43 is voted for the position of (2, 1) for the character category [symbol] , the mesh m43 is voted for the position of (1, 3) for the character category [symbol] , and the mesh m104 is voted for the position of (4, 4) for the character category [symbol] .

Next, the position-consistency determining unit 35 compares the positional relationship of the input image with the positional relationship in the character category, for the partial input images voted for the character categories, and determines their consistency. Specifically, the position-consistency determining unit 35 creates a graph by connecting between nodes keeping a relationship between the meshes of the character category and a relationship between the meshes of the input image, by a path, using as the nodes, the partial input images voted for the positions of the same character category.

FIG. 6 is a schematic diagram for explaining graphing of partial input images by the position-consistency determining unit 35. In FIG. 6, all partial input images cut out from the input image including: a mesh m21, the mesh m43, the mesh m104, a mesh m105, a mesh m108, are voted for the character category [symbol] .

The mesh m21 is voted for (1, 1) of the character category [symbol] . Similarly, the mesh m43 is voted for (2, 1), the mesh m44 is voted for (2, 2), the mesh m104 is voted for (5, 4), the mesh m105 is voted for (5, 5), and the mesh m108 is voted for (4, 4).

The position-consistency determining unit 35 draws a path based on the positional relationship between nodes, using all partial input images registered to [symbol] , i.e., using the mesh m21, the mesh m43, the mesh m44, the mesh m104, the mesh m105, and the mesh m108, as the nodes.

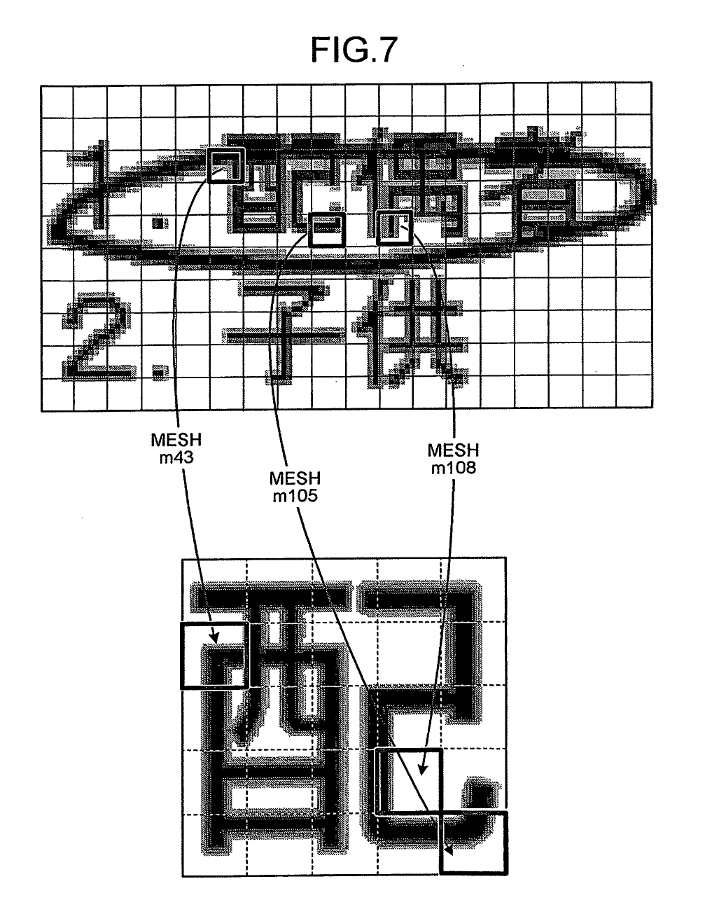

FIG. 7 is a schematic diagram for explaining a path connection between the nodes. The node connection is explained with reference to FIG. 7, taking as an example a positional relationship among the mesh m43, the mesh m105, and the mesh m108.

First, the mesh m43 and the mesh m105 are considered. In the input image, the mesh m105 is positioned at the right lower direction of the mesh m43. In the character category, the mesh m105 is also positioned at the right lower direction of the mesh m43. In this way, the relative positional relationship between the mesh m43 and the mesh m105 in the input image is consistent with the relative positional relationship between the mesh m43 and the mesh m105 in the character category, i.e., their positional relationship are consistent. Therefore, a path is drawn between the mesh m43 and the mesh m105 (see FIG. 6).

Next, the mesh m105 and the mesh m108 are considered. In the input image, the mesh m108 is positioned at the right direction of the mesh m105 at the same height. On the other hand, in the character category, the mesh m108 is positioned at the left upper direction of the mesh m105. As explained above, the relative positional relationship between the mesh m105 and the mesh m108 in the input image is not consistent with the relative positional relationship between the mesh m105 and the mesh m108 in the character category. Therefore, a path is not drawn between the mesh m105 and the mesh m108 (see FIG. 6).

Next, the mesh m43 and the mesh m108 are considered. In the input image, the mesh m108 is positioned at the right lower direction of the mesh m43. In the character category, the mesh m108 is also positioned at the right lower direction of the mesh m43. In this way, the relative positional relationship between the mesh m43 and the mesh m105 in the input image is consistent with the relative positional relationship between the mesh m43 and the mesh m108 in the character category. Therefore, a path is drawn between the mesh m43 and the mesh m108 (see FIG. 6).

The position-consistency determining unit 35 checks for each character category whether the positional relationships satisfy the two relationships of all the voted meshes, and creates a graph. Thereafter, the position-consistency determining unit 35 extracts a clique from the graph. The clique corresponds to a set of partial input images whose positional relationship matches that of the partial character image, and becomes a character candidate in the input image. Various algorithms are available for extracting a clique from the graph (for example, C. Bron and J. Kerbosch Algorithm 457. Finding all cliques of an undirected graph [H]. Comm. ACM. 16(9), September 1973).

The character determining unit 36 identifies with which identification area the character category matches, by evaluating the clique extracted by the position-consistency determining unit 35. Specifically, when the number of nodes of the clique is equal to or larger than a threshold value, the character determining unit 36 determines that the character category is present in the area corresponding to the node, by regarding that the relationship is correct.

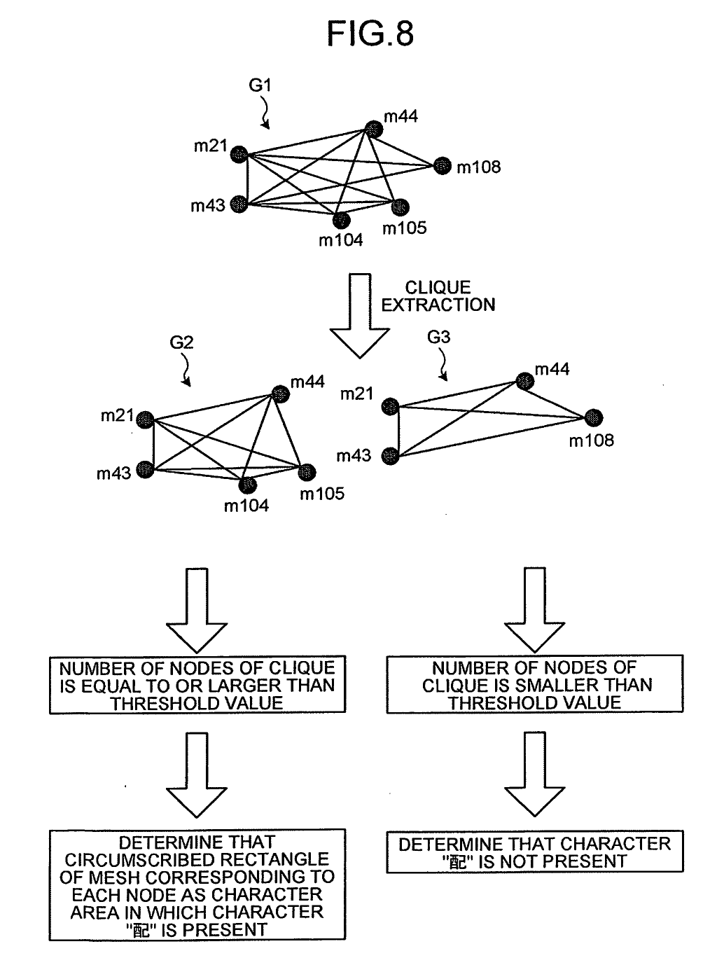

FIG. 8 is a schematic diagram for explaining extraction and evaluation of a clique. As shown in FIG. 8, when a clique is extracted from a graph G1 having the mesh m21, the mesh m43, the mesh m44, the mesh 104, the mesh m105, and the mesh m108, there can be obtained a clique G2 having five nodes: the mesh m21, the mesh m43, the mesh m44, the mesh m104, and the mesh m105, and a clique G3 having four nodes: the mesh m21, the mesh m43, the mesh m44, and the mesh m108.

When the determination threshold value is 5, i.e., the clique G2 has the number of nodes equal to or larger than the threshold value, the character determining unit 36 determines that the area in the input image corresponding to the nodes of the clique G2 is the character area where the character [symbol] is present, On the other hand, the number of nodes of the clique G3 is less than the threshold value, and thus the character determining unit 36 determines that the nodes of the clique G3 do not represent the character [symbol] .

More specifically, the character determining unit 36 obtains a rectangle circumscribed about the partial input images corresponding to each node, for the clique having nodes equal to or more than a threshold value, and recognizes this circumscribed rectangle as a character area.

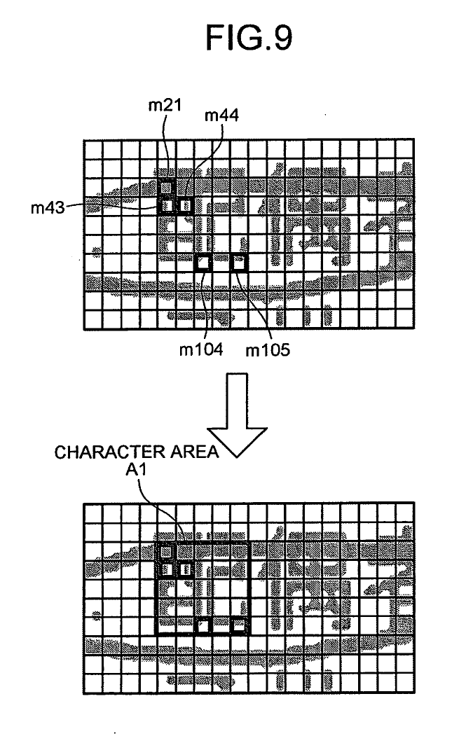

FIG. 9 is a schematic diagram for explaining recognition of a character area by the character determining unit 36. In FIG. 9, the character determining unit 36 determines that the rectangle circumscribed by the mesh m21, the mesh m43, the mesh m104, and the mesh m105 constituting the clique G2 is a character area A1, and recognizes that the character [symbol] is present in this character area A1.

When a plurality of same characters are present in the input image, the character determining unit 36 creates one graph from all characters of the same category. Thereafter, a plurality of cliques, each having nodes of which number exceeding a threshold value, are extracted from the graph, and each clique constitutes mutually different character areas in the input image.

It is explained above the operation of the processing unit, using a conceptual drawing to make clear a positional relationship with the input image in the character category. Data actually generated and used in each process is stored in the storage unit 15 in a format suitable for processing in the apparatus.

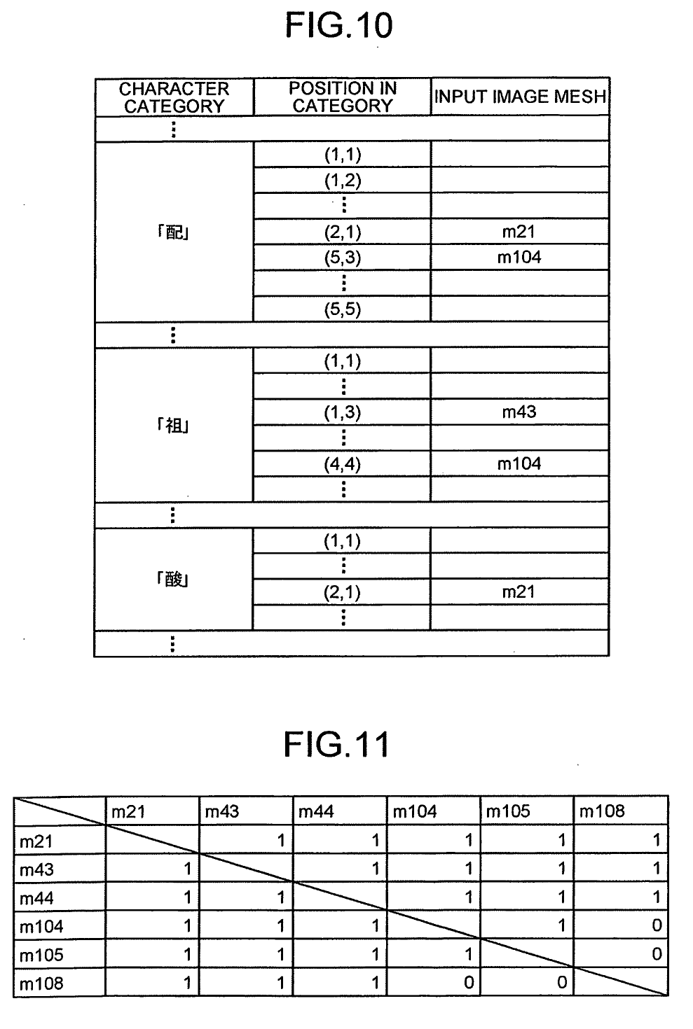

FIG. 10 is an example of vote result data that the position-consistency determining unit 35 generates from a search result obtained by the character-category searching unit 34. The vote result data is obtained as a result of counting by the position-consistency determining unit 35 previously described in connection with FIG. 5, and the vote result data holds data in the format of a table having three items of character category, intra-category position, and input image mesh.

FIG. 11 is an example of graph data generated by the position-consistency determining unit 35. This graph data holds a value “1” when a path is connected, and holds data in a format of the table having a value “0” when a path is not connected, between the nodes held by the graph.

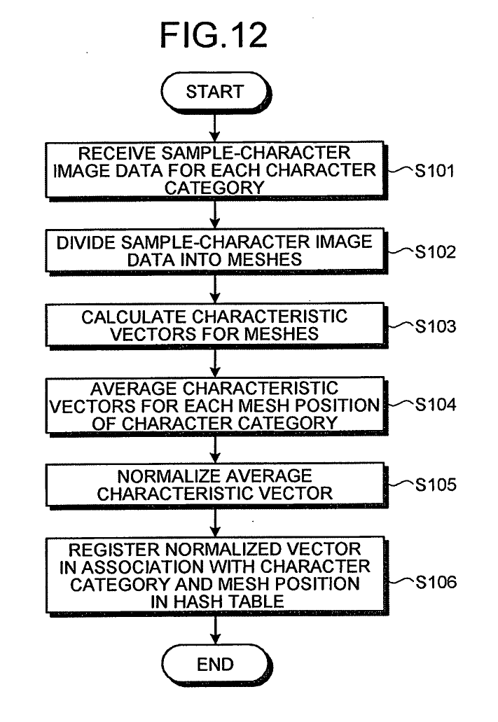

FIG. 12 is a flowchart of a process of hash-table registration performed by the character recognition apparatus 1. As shown in FIG. 12, the hash-table registering unit 22 receives, via the interface 14, a plurality of sets of sample-character image data for each character category (step S101).

The hash-table registering unit 22 divides the sample-character image data into meshes (step S102), and calculates characteristic vectors for the respective meshes, i.e., for respective partial character images (step S103).

Thereafter, the hash-table registering unit 22 averages the characteristic vectors for each mesh position of the character category (step S104), and normalizes the average characteristic vector (step S105). The hash-table registering unit 22 registers the normalized characteristic vector in association with the character category and the mesh position in the hash table (step S106), and the process ends. The hash-table registering unit 22 performs the above process for each character category to create the hash table.

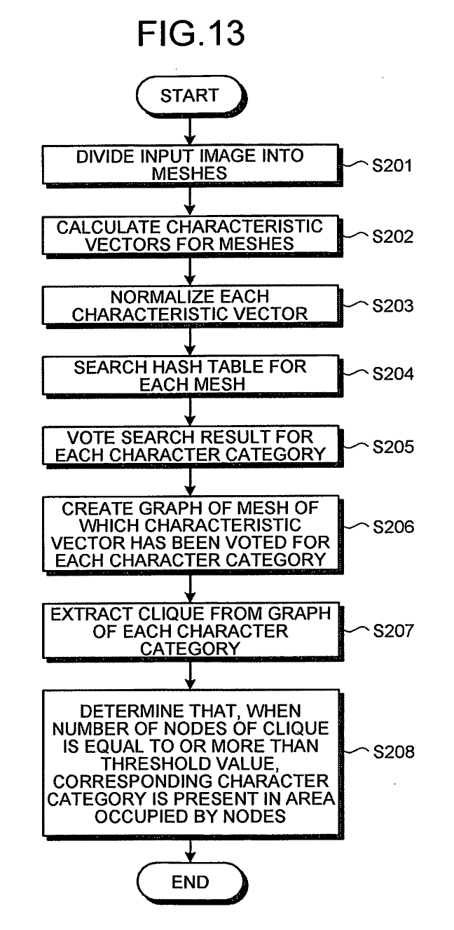

FIG. 13 is a flowchart of a process of character recognition. As shown in FIG. 13, the mesh dividing unit 31 divides the input image read by the reading unit 13 into meshes (step S201). Next, the characteristic calculating unit 32 calculates characteristic vectors for the respective meshes (partial input images) (step S202). The normalizing unit 33 normalizes each characteristic vector (step S203). The character-category searching unit 34 searches the hash table for the normalized characteristic vector as a key for each mesh (step S204).

The position-consistency determining unit 35 votes a characteristic vector for each character category based on the search result (step S205), and creates a graph having as a node a mesh (partial input image) of the input image voted for the same character category (step S206). Upon creation of the graph, a path is drawn between the nodes by comparing between the positional relationship of the part image areas corresponding to each node in the input image and the positional relationship in the character category, as described above.

The position-consistency determining unit 35 extracts a clique from the graph of each character category (step S207). The character determining unit 36 determines that, when the number of nodes of a clique exceeds a threshold value, a character category corresponding to the area occupied by the nodes is present (step S208), and ends the process.

A modification of the hash-table registration and the character recognition is explained next. In searching a partial character image of which characteristic is similar to that of the partial input image, a similarity can be calculated from a distance between characteristic vectors of the partial character image and a distance between characteristic vectors of the partial character image, and determining that the vectors are similar to each other when the similarity is equal to or larger than the threshold value. However, the calculation takes time when a combination of similarity is searched by measuring a distance between vectors. Therefore, the character recognition apparatus 1 converts the characteristic vectors of the partial character image into a hash value, and draws a position of the character category and the mesh from the hash value, thereby increasing the recognition process.

Specifically, the character recognition apparatus 1 simplifies the calculation of similarity by normalizing the similarity values to become the same value, at the time of generating the hash value from the characteristic vectors. In the above example, an integer quotient is obtained by dividing the value of each dimension of the characteristic vectors by a predetermined number. When the quotient exceeds 9, the quotient is forcibly replaced by 9. A modification of the above method is explained next.

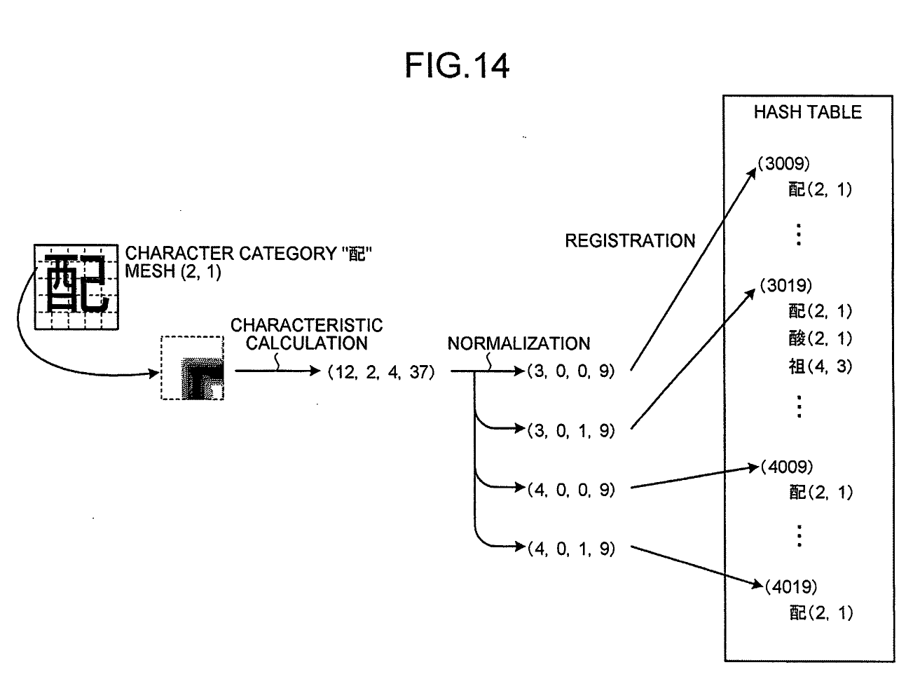

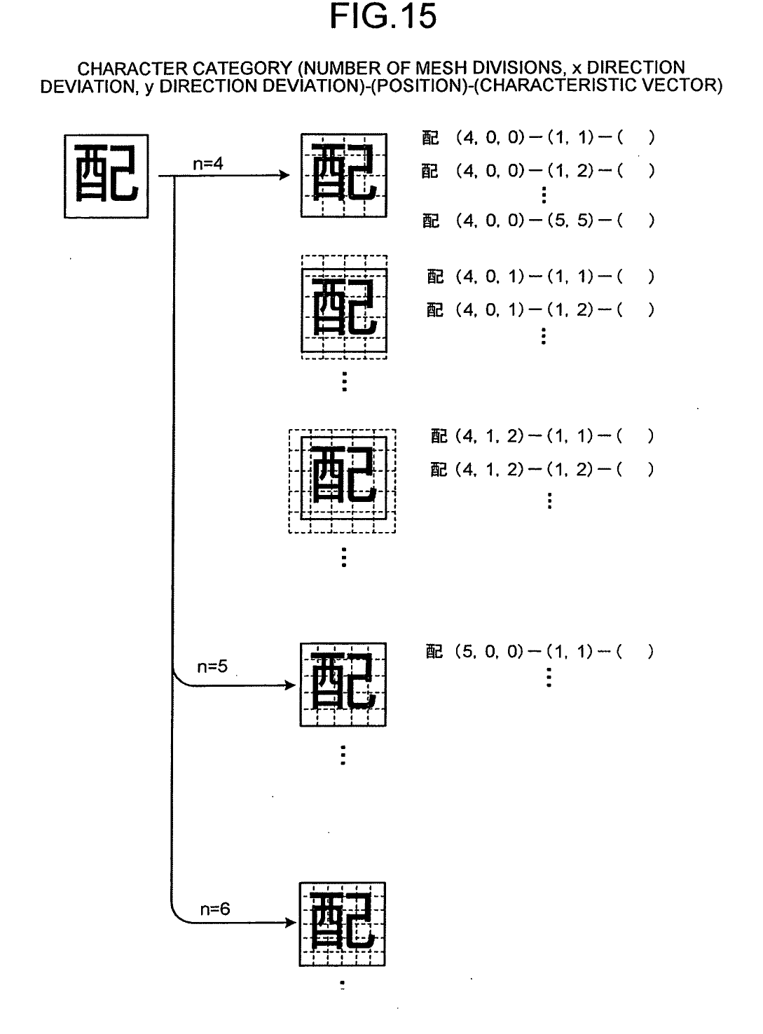

FIG. 14 is a schematic diagram for explaining a modification of normalization at the time of creating a hash table. In FIG. 14, an integer a and an integer b (a>b) are determined beforehand, and an integer quotient of (xi±b)/a is obtained for four-dimensional vector values (x1, x2, x3, x4). When this quotient exceeds 9, the integer quotient is forcibly replaced by 9.

For example, assume that the characteristic vectors of (2, 1) of the character category [symbol] are (12, 2, 4, 37), and a=4 and b=1. There can be obtained (12+1)/4=3 and (12−1)/4=2 as normalized values of x1, (2+1)/4=0 and(2−1)/4=0 as normalized values of x2, (4+1)/4=1 and (4−1)/4=0 as normalized values of x3, and (37+1)/4=9 and (37−1)/4=9 as normalized values of x4, respectively. The following four combinations (3, 0, 0, 9), (3, 0, 1, 9), (4, 0, 0, 9), and (4, 0, 1, 9) are obtained from the above. In this case, four combinations of characteristic vectors are registered in the hash table, corresponding to (2, 1) of the character category [symbol] .

When the hash values have a width corresponding to certain characteristic vectors, and when these hash values are registered in the hash table by relating a plurality of hash values to the combinations of a character category and mesh positions, it is possible to obtain effects similar to those when the threshold value is lowered in the comparison of similarity, i.e., characteristic vectors having lower similarity can be obtained as a search result.

In performing a mesh division to a sample character image or an input image, values of characteristic vectors of meshes are changed depending on mesh positions. Therefore, at the time of creating a hash table, preferably mesh characteristic vectors of a sample character are registered in multiple, considering slightly-shifted meshes. It is sufficient to calculate mesh characteristic vectors using one mesh. Similarly, regarding a mesh size, mesh characteristic vectors of a character are also registered in multiple, considering a plurality of sizes.

FIG. 15 is a schematic diagram for explaining application of different mesh divisions to one character image. In FIG. 15, in dividing the character image by n×n, the character image is divided in three mesh sizes of n=4, 5, and 6. In addition to this, characteristics are similarly obtained for meshes shifted by a few pixels to the x direction and the y direction, respectively, for each division size.

Characteristic vectors obtained by performing mesh division having no deviation to the x direction and the y direction by the division number n are set as (n, 0, 0) characteristics of the character category. Characteristic vectors obtained by performing mesh division having deviation to the x direction and the y direction by the division number n are set as (n, dx, dy) characteristics of the character category. For dx and dy, when two values are set to equally divide the meshes into three, there can be set nine characteristics, including (n, 0, 0) characteristic, (n, 0, 1) characteristic, (n, 0, 2) characteristic, (n, 1, 0) characteristic, (n, 1, 1) characteristic, (n, 1, 2) characteristic, (n, 2, 0) characteristic, (n, 2, 1) characteristic, and (n, 2, 2) characteristic. When one side of one mesh has six pixels, the mesh can be equally divided into three, by shifting each two pixels.

In this way, 27 (n, dx, dy) characteristics (n=4, 5, 6; dx=0, 1, 2; dy=1, 1, 2) are obtained, and these are registered in the hash table. Values of characteristics are expressed by (n, dx, dy)−(i, j)−(v1, v2, v3, v4), based on a row number i, a column number j, and characteristic vectors (v1, v2, v3, v4), by regarding the meshes as a matrix. The characteristic vectors can be registered by relating the (character category name, n, dx, dy, i, j) to the hash value H calculated from the characteristic vectors (v1, v2, v3, v4).

In the recognition process after the obtained (n, dx, dy) characteristics are registered in the hash table, a plurality of character images having different mesh sizes and different mesh positions are obtained as a search result. Therefore, positional relationships are made consistent by projecting respective search results to the character category.

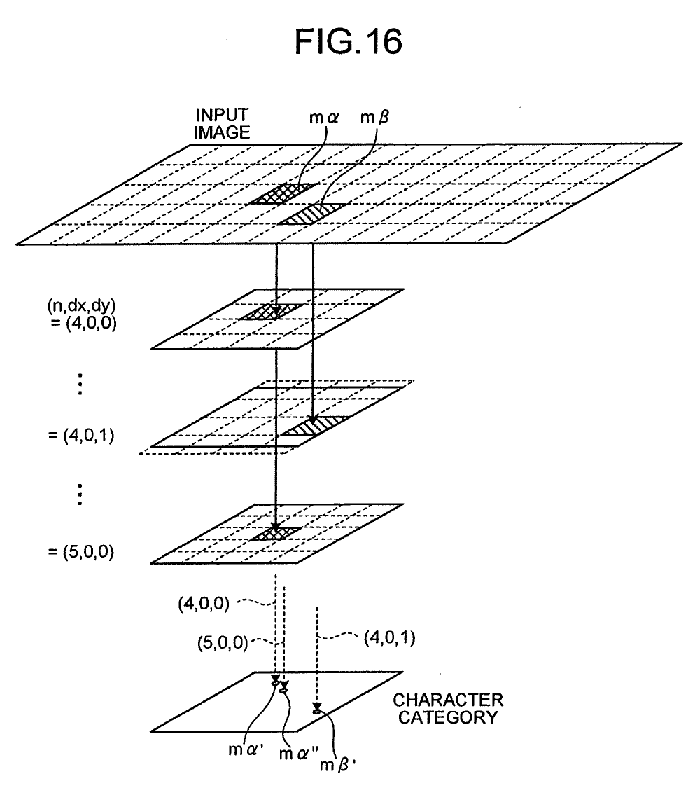

FIG. 16 is a schematic diagram for explaining the recognition process based on the (n, dx, dy) characteristics. In FIG. 16, partial character images are present corresponding to the (4, 0, 0) characteristic and (5, 0, 0) characteristic relative to a mesh ma on the input image, and partial character images are present corresponding to the (4, 0, 1) characteristic relative to a mesh mβ on the input image. In this case, when the position of each partial character image is projected on the character category, for the mesh mα, there can be obtained mα′ as a projection image of (4, 0, 0), and mα″ as a projection image of (5, 0, 0). Similarly, for the mesh mβ, mβ′ can be obtained as a projection image of (4, 0, 1).

Even when characteristic vectors having different sizes and different positions of mesh divisions are present together in this way, mutual positional relationships can be evaluated by projecting the character images to the character category. When a plurality of projection images mα′ and mα″ are obtained from one partial input image mα, respective projection images are handled as individual nodes.

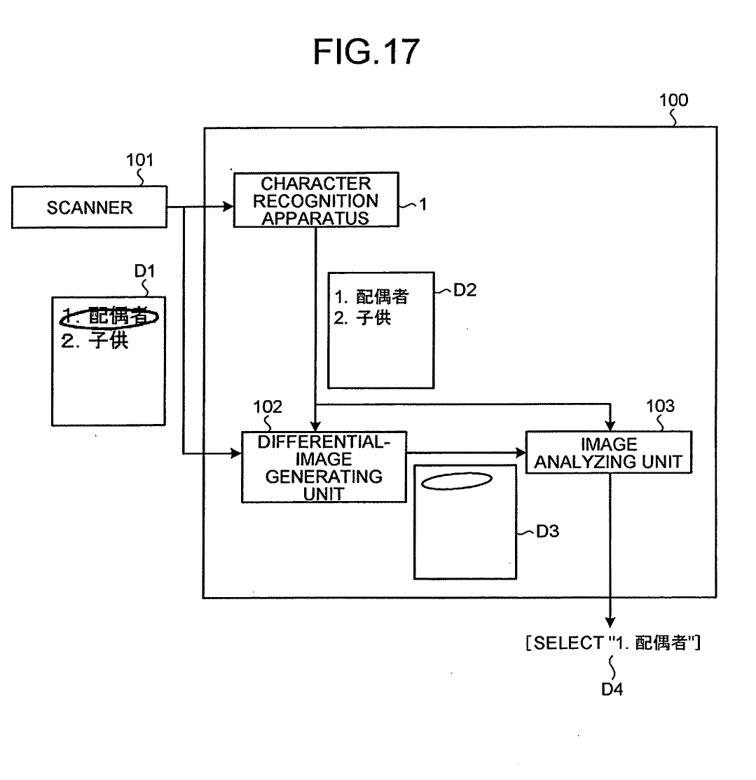

FIG. 17 is a schematic diagram of an image recognition system 100 according to the embodiment. The image recognition system 100 is connected to a scanner 101, and obtains image data D1 read by the scanner 101. The image data D1 is an application sheet or an enquiry in which a character string and a number are directly marked by hand in a selection column. The handwritten mark is overlapped with a character pattern.

The image recognition system 100 includes therein the character recognition apparatus 1, a differential-image generating unit 102, and an image analyzing unit 103. As explained above, the character recognition apparatus 1 recognizes a character of the image data D1, and outputs image data D2 as a recognition result. The image data D2 represents what character is present at what position within the image.

The differential-image generating unit 102 differentiates between the image data D1 and the image data D1, thereby generating image data D3. The image data D1 has a handwritten mark overlapped with the character, and the image data D2 contains only a character. Therefore, the image data D3 as this difference becomes the image having the handwritten mark extracted.

The image analyzing unit 103 outputs which selection alternative is selected from a position of the handwritten mark shown in the image data D3, and a character and its position shown in the imaged data D2. In FIG. 17, the image analyzing unit 103 can output analysis result data D4 expressing that the image data D1 represents selection of “1. [symbol] .

As explained above, in the character recognition apparatus 1, the hash-table registering unit 22 creates the hash table 16 expressing the characteristics of the partial input images as local areas of each character category. The recognition processing unit 21 divides the input image into meshes having partial input images, calculates characteristics of each partial input image, retrieves a partial character image of which characteristic is similar to the characteristic of each partial input image in the hash table, compares the positional relationship of the partial input image with the positional relationship of the partial character image, evaluates their consistency, and recognizes what character is present in which area of the input image.

Therefore, the character recognition apparatus 1 can recognize a character using a part having no overlapping of character patterns, without separating the character pattern from other patterns than the character in the input image. The character recognition apparatus 1 can recognize the character pattern, regardless of the shape of the pattern other than the character in contact with the character pattern, and regardless of the way of contact. The character recognition apparatus 1 divides the image into meshes, obtains similarity for each mesh, and obtains total similarity from the consistency of their positions, thereby recognizing the character. Therefore, the character recognition apparatus 1 can recognize the character without the need of cutting out a character area in a character unit from the image.

For example, in the above description, hash-table registration by the hash-table registering unit 22 and character recognition by the recognition processing unit 21 are performed while switched from one to another. Alternatively, only character recognition can be performed based on a hash table created by another apparatus.

It is also possible to perform, in an arbitrary manner, operations such as calculation of characteristics of partial input images and partial character images, search for character categories having similar characteristics, and determination of consistency of positional relationships of partial input images and partial character images. For example, in the above embodiment, at the time of drawing a path between nodes, consistency of positional relationships is determined based on a relative direction between meshes. Alternatively, a distance between meshes can be also used as a determination standard of consistency between positional relationships.

The character recognition apparatus 1 is explained above as hardware; however, it can be implemented as software. In other words, a computer program (hereinafter, “character recognition program”) can be executed on a computer to realize the same function as the character recognition apparatus 1. In the following, such a computer is explained.

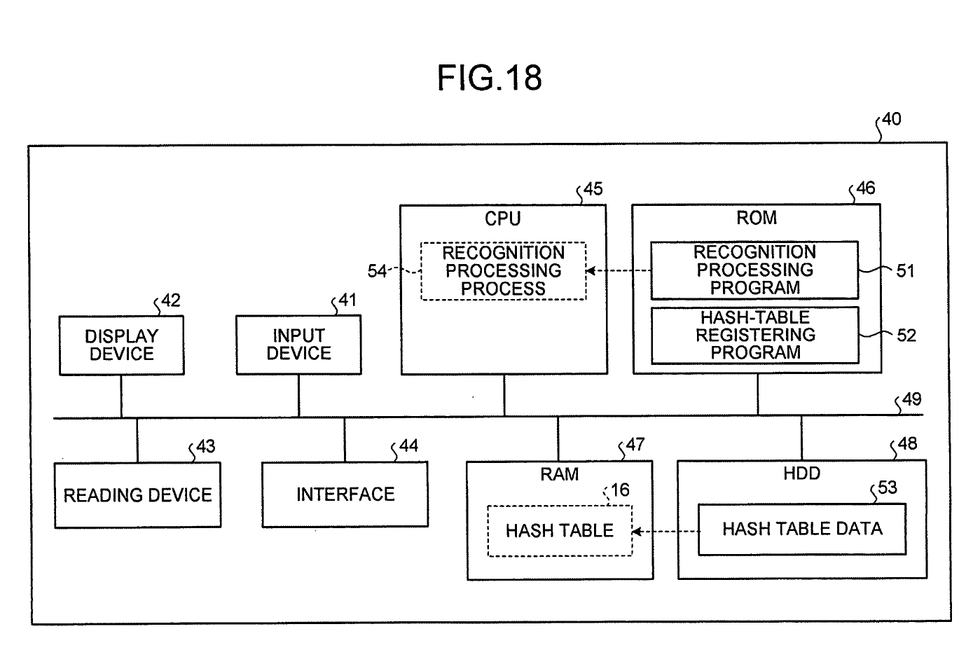

FIG. 18 is a schematic diagram of a computer 40 that executes the character recognition program. The computer 40 includes an input device 41, a display device 42, a reading device 43, an interface 44, a central processing unit (CPU) 45, a read only memory (ROM) 46, a random access memory (RAM) 47, and a hard disk drive (HDD) 48, which are connected to each other via a bus 49. The input device 41 corresponds to the input unit 11, the display device 42 corresponds to the display unit 12, and the reading device 43 and the interface 44 correspond to the reading unit 13 and the interface 14.

The ROM 46 stores in advance a computer program (hereinafter “recognition processing program”) 51 and a computer program (hereinafter “hash-table registering program”) 52 that implement the same functions as the recognition processing unit 21 and the hash-table registering unit 22, respectively.

The CPU 45 reads the recognition processing program 51 and the hash-table registering program 52 from the ROM 46. For example, in FIG. 18, the CPU 45 reads the recognition processing program 51 from the ROM 46 to perform a recognition processing process 54, and the CPU 45 can realize the same function as the recognition processing unit 21.

The HDD 48 stores therein hash table data 53 as shown in FIG. 18. The CPU 45 reads the hash table data 53, and loads this data into the RAM 47 to implement the hash table 16 as described above.

The recognition processing program 51 and the hash-table registering program 52 need not necessarily be stored in advance in the ROM 46. Each program can be stored in a portable physical medium such as a flexible disk (FD), a compact-disk read only memory (CD-ROM), a magnetic optical (MO) disk, a digital versatile disk (DVD), an optical magnetic disk, and an integrated circuit (IC) card, or a fixed physical medium such as a hard disk drive (HDD) inside or outside the computer 40. Each program can also be stored in another computer (or server) connected to the computer 40 via, for example, a public line, the Internet, a local area network (LAN), and a wide area network (WAN), so that the computer 40 can download it therefrom.

As set forth hereinabove, according to an embodiment of the present invention, a character image overlapped with a pattern in an arbitrary shape can be recognized with high accuracy at high speed. Moreover, an area where a character is present in an input image can be easily specified. Furthermore, characteristics similar to those of partial input images can be easily retrieved, which further increases character recognition speed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for character recognition, the computer program causing a computer to execute:
first dividing each of a plurality of character images into a plurality of partial character images each representing a part of a character image;
storing, in a search table, a characteristic of each of the partial character images in association with a positional relationship between the partial character images in the character image and a character type of the character image;
second dividing an input image into a plurality of partial input images;
calculating a characteristic of each of the partial input images;
searching the search table for a partial character image having a characteristic similar to the characteristic calculated at the calculating;
counting partial character images obtained at the searching for each character type;
determining whether a positional relationship between the partial character images matches a positional relationship between the partial input images for each character type;
extracting, when the positional relationship between the partial character images matches the positional relationship between the partial input images, the partial input images as a character candidate; and
recognizing, when number of the partial input images of the character candidate is equal to or more than a predetermined value, the partial input images as constituent elements of a character represented by the character type.

2. The computer-readable recording medium according to claim 1, wherein the determining includes
setting, among the partial input images, a partial input image similar to a partial character image of same character type as a node; and
creating a graph by connecting nodes having a relative positional relationship that matches a relative positional relationship between partial character images corresponding to the nodes; and
extracting a clique of the graph as the character candidate.

3. The computer-readable recording medium according to claim 1, wherein the recognizing includes, when number of the partial input images of the character candidate is equal to or more than a predetermined value, obtaining a rectangle circumscribed about a set of the partial input images, and recognizing that the character represented by the character type is present in the rectangle.

4. The computer-readable recording medium according to claim 1, wherein
the first dividing includes dividing one character image into partial character images having at least one of different sizes and different positional relationships, and
the search table stores therein a characteristic of each of the partial character images in association with a positional relationship between the partial character images in the character image and a character type of the character image.

5. The computer-readable recording medium according to claim 1, wherein the search table associates a plurality of similar characteristics with the partial character image, and stores therein each of the characteristics in association with the positional relationship between the partial character images in the character image and the character type of the character image.

6. A character recognition apparatus that recognizes a character in an input image, the apparatus comprising:
a first dividing unit that divides each of a plurality of character images into a plurality of partial character images each representing a part of a character image;
a storage unit that stores therein a search table that associates a characteristic of each of the partial character images with a positional relationship between the partial character images in the character image and a character type of the character image;
a second dividing unit that divides the input image into a plurality of partial input images;
a calculating unit that calculates a characteristic of each of the partial input images;
a searching unit that searches the search table for a partial character image having a characteristic similar to the characteristic calculated by the calculating unit;
a determining unit that counts, for each character type, partial character images obtained by the searching unit, and determines whether a positional relationship between the partial character images matches a positional relationship between the partial input images;
an extracting unit that extracts, when the positional relationship between the partial character images matches the positional relationship between the partial input images, the partial input images as a character candidate; and
a recognizing unit that recognizes, when number of the partial input images of the character candidate is equal to or more than a predetermined value, the partial input images as constituent elements of a character represented by the character type.

7. The character recognition apparatus according to claim 6, wherein the determining unit sets, among the partial input images, a partial input image similar to a partial character image of same character type as a node, creates a graph by connecting nodes having a relative positional relationship that matches a relative positional relationship between partial character images corresponding to the nodes, and extracts a clique of the graph as the character candidate.

8. The character recognition apparatus according to claim 6, wherein, when number of the partial input images of the character candidate is equal to or more than a predetermined value, the recognizing unit obtains a rectangle circumscribed about a set of the partial input images, and recognizes that the character represented by the character type is present in the rectangle.

9. The character recognition apparatus according to claim 6, wherein
the first dividing unit that divides one character image into partial character images having at least one of different sizes and different positional relationships, and
the search table stores therein a characteristic of each of the partial character images in association with a positional relationship between the partial character images in the character image and a character type of the character image.

10. The character recognition apparatus according to claim 6, wherein the search table associates a plurality of similar characteristics with the partial character image, and stores therein each of the characteristics in association with the positional relationship between the partial character images in the character image and the character type of the character image.

11. A character recognition method for recognizing a character in an input image, the method comprising:
first dividing each of a plurality of character images into a plurality of partial character images each representing a part of a character image;
storing, in a search table, a characteristic of each of the partial character images in association with a positional relationship between the partial character images in the character image and a character type of the character image;
second dividing an input image into a plurality of partial input images;
calculating a characteristic of each of the partial input images;
searching the search table for a partial character image having a characteristic similar to the characteristic calculated at the calculating;
counting partial character images obtained at the searching for each character type;
determining whether a positional relationship between the partial character images matches a positional relationship between the partial input images for each character type;
extracting, when the positional relationship between the partial character images matches the positional relationship between the partial input images, the partial input images as a character candidate; and
recognizing, when number of the partial input images of the character candidate is equal to or more than a predetermined value, the partial input images as constituent elements of a character represented by the character type.

12. The character recognition method according to claim 11, wherein the determining includes
setting, among the partial input images, a partial input image similar to a partial character image of same character type as a node; and
creating a graph by connecting nodes having a relative positional relationship that matches a relative positional relationship between partial character images corresponding to the nodes; and
extracting a clique of the graph as the character candidate.

13. The character recognition method according to claim 11, wherein the recognizing includes, when number of the partial input images of the character candidate is equal to or more than a predetermined value, obtaining a rectangle circumscribed about a set of the partial input images, and recognizing that the character represented by the character type is present in the rectangle.

14. The character recognition method according to claim 11, wherein
the first dividing includes dividing one character image into partial character images having at least one of different sizes and different positional relationships, and
the search table stores therein a characteristic of each of the partial character images in association with a positional relationship between the partial character images in the character image and a character type of the character image.

15. The character recognition method according to claim 11, wherein the search table associates a plurality of similar characteristics with the partial character image, and stores therein each of the characteristics in association with the positional relationship between the partial character images in the character image and the character type of the character image.
